(19) United States
(12) Patent Application Publication
(10) Pub. No.: US 2013/0004829 A1
(43) Pub. Date: Jan. 3, 2013

(54) Heterogeneous Ohmic Contact for a Voltaic Cell

(75) Inventor: Chad Allison, South Lyon, MI (US)

(73) Assignee: A123 SYSTEMS, INC., Waltham, MA (US)

(21) Appl. No.: 13/540,387

(22) Filed: Jul. 2, 2012

Related U.S. Application Data
(60) Provisional application No. 61/503,829, filed on Jul. 1, 2011.

(51) Int. Cl. H01M 4/64; H01M 2/02; H01M 4/04; H01M 4/66

(52) U.S. Cl. 429/157; 429/211; 429/163; 29/623.1

(57) ABSTRACT

An electrochemical cell has first and second electroactive layers, a heterogeneous ohmic contact, and a homogeneous ohmic contact. The heterogeneous ohmic contact includes dissimilar first and second conductors, with the first conductor joined to the first electroactive layer and the second conductor oriented opposite the first electroactive layer. The homogeneous ohmic contact includes the second conductor, joined to the second electroactive layer.

### CROSS REFERENCE TO RELATED APPLICATIONS

This application claims priority to U.S. Provisional Patent Application Ser. No. 61/503,829, filed Jul. 1, 2011 and entitled HETEROGENEOUS OHMIC CONTACT FOR A VOLTAIC CELL, the entirety of which is hereby incorporated herein by reference for all intents and purposes.

### TECHNICAL FIELD

This application relates to the field of electrochemical engineering, and more particularly, to an electrochemical storage battery.

### BACKGROUND

An electrochemical storage battery may include a plurality of electrochemical cells connected in series, for increased voltage, or in parallel for increased current handling. Each cell includes a positive electrode and a negative electrode, which differ from each other in material composition. In a lithium-ion cell, for example, the negative electrode is a lithium-ion intercalated, reduced-carbon material dispersed on a copper substrate, and the positive electrode is a lithium metal oxide dispersed on an aluminum substrate. Electrical contact to the electrodes of the cell is made via uncoated portions of the substrates. In some cases, contact is made by welding a compatible contact to the uncoated portions of the substrates. For example, a copper contact may be welded to the copper substrate of the negative electrode, and an aluminum contact may be welded to the aluminum substrate of the positive electrode. Accordingly, in the finished cell, the external contact to the negative electrode may be made of copper and the external contact to the positive electrode may be made of aluminum.

The above approach may present difficulty in applications in which a plurality of cells are welded together to form a storage battery. This is because a mixed-metal weld reliable enough to connect the cells of the storage battery may be difficult to achieve—especially so when environmental factors such as thermal stresses and vibration are taken into account.

### SUMMARY

Accordingly, one embodiment of this disclosure provides an electrochemical cell having first and second electroactive layers, a heterogeneous ohmic contact, and a homogeneous ohmic contact. The heterogeneous ohmic contact includes dissimilar first and second conductors, with the first conductor joined to the first electroactive layer and the second conductor oriented opposite the first electroactive layer. The homogeneous ohmic contact is made of the second conductor, and is joined to the second electroactive layer.

The summary above is provided to introduce a selected part of this disclosure in simplified form, not to identify key or essential features. The claimed subject matter, defined by the claims, is limited neither to the content of this summary nor to implementations that address problems or disadvantages noted herein.

### BRIEF DESCRIPTION OF THE DRAWINGS

FIG. 1 shows aspects of a prismatic voltaic cell in accordance with an embodiment of this disclosure.

FIGS. 2 and 3 show aspects of the internal structure of a prismatic voltaic cell in accordance with an embodiment of this disclosure.

FIG. 4 shows aspects of a heterogeneous ohmic contact in accordance with an embodiment of this disclosure.

FIG. 5 shows aspects of a storage battery in accordance with an embodiment of this disclosure.

FIG. 6 illustrates an example method for making a storage battery in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

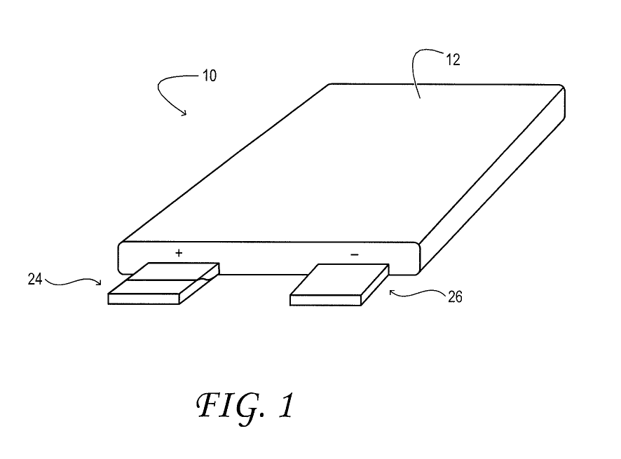

FIG. 1 is a view showing aspects of an example electrochemical cell 10 in one embodiment. The internal contents of the cell (not shown in FIG. 1) are enclosed by envelope 12. The cell may be one of a plurality of voltaic cells of a rechargeable storage battery. In the illustrated embodiment, the cell is a prismatic voltaic cell. In a more particular embodiment, the cell may be a prismatic lithium ion cell.

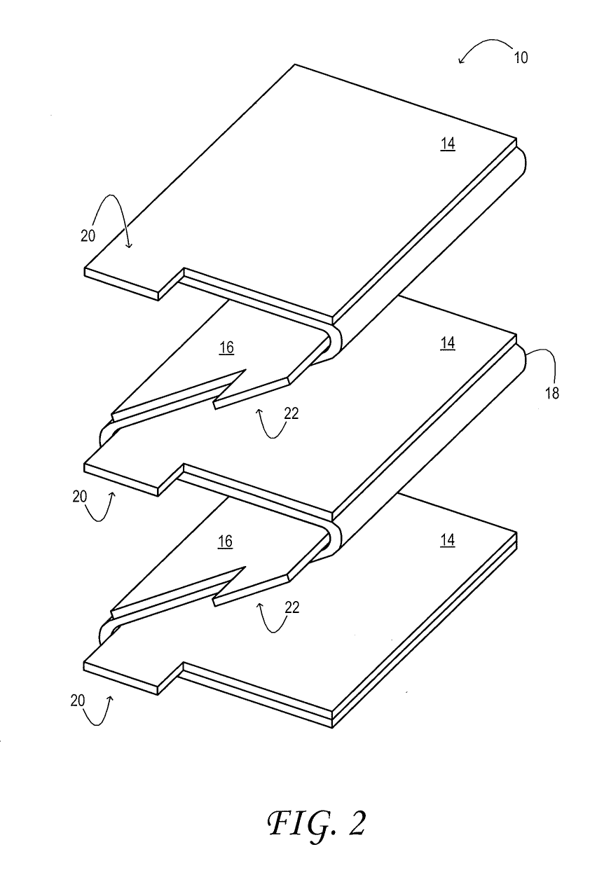

FIG. 2 shows aspects of the internal structure of cell 10 in one embodiment. The cell includes first electroactive layer 14 and second electroactive layer 16. The first and second electroactive layers are arranged on opposite sides of a separation layer 18, which may comprise a suitably porous fabric. The nature of the electroactive layers will vary depending on the kind of electrochemical cell being constructed. In general, the first (or second) electroactive layer may be the positive electrode of the cell, and the second (or first) electroactive layer may be the negative electrode. Although both variants are equally contemplated and equally consistent with this disclosure, the first electroactive layer will be identified hereinafter as the positive electrode, for ease of description. In embodiments in which the cell is a lithium-ion cell, the first electroactive layer may comprise a lithium metal oxide dispersed on an aluminum substrate; here, the second electroactive layer may comprise a lithium-ion intercalated, reduced-carbon material dispersed on a copper substrate.

As shown in FIG. 2, first electroactive layer 14 and second electroactive layer 16 may be arranged on alternating segments and opposite sides of separation layer 18. In the illustrated embodiment, electrical contact to the first and second electroactive layers is made via two or more ohmic contacts joined to tab portions of the electroactive layers. Accordingly, FIG. 2 shows a plurality of tab portions 20 of the first electroactive layer, and a plurality of tab portions 22 of the second electroactive layer. Each tab portion may comprise an uncoated substrate portion of the electroactive layer to which it belongs. The tab portions may protrude beyond the separation layer to permit attachment to each other and to the ohmic contacts of cell 10.

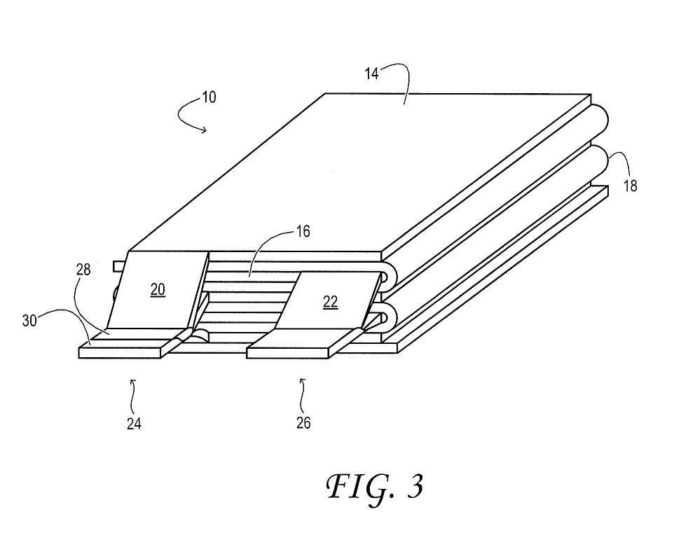

FIG. 3 shows aspects of the internal structure of cell 10 at a later stage of the fabrication process. At this stage, separation layer 18, first electroactive layer 14, and second electroactive layer 16 are folded up in a zig-zag arrangement. Although the drawing figures relate to this so-called ‘Z-folded’ configuration, other internal cell structures are contemplated as well, including crush-wound and flat-wound structures. As indicated above, the first and second electroactive layers may each include a plurality of tab portions. The separation layer and the first and second electroactive layers are folded such that the tab portions of the first electroactive layer are arranged in registry with each other, and the tab portions of the second electroactive layer are arranged in registry with each other. The plurality of tab portions of the first electroactive layer are joined together—e.g., by welding—as are the plurality of tab portions of the second electroactive layer.

FIG. 3 shows heterogeneous ohmic contact 24 and homogeneous ohmic contact 26. The heterogeneous ohmic contact is joined to the tab portions of first electroactive layer 14, while the homogeneous ohmic contact is joined to the tab portions of second electroactive layer 16. In this manner, the heterogeneous ohmic contact is electrically connected to the first electroactive layer, and the homogeneous ohmic contact is connected to the second electroactive layer.

In one embodiment, heterogeneous ohmic contact 24 and homogeneous ohmic contact 26 may be rectangular metal sheets—e.g., 45-millimeter (mm) square sheets. The sheets may be of any suitable thickness—0.3 mm or 0.6 mm, for example—but may taper down to a knife edge. The knife edge is provided so that the internal cell contents can be easily sealed in envelope 12 with the ohmic contacts extending through the envelope.

In the embodiments considered herein, homogeneous ohmic contact 26 may comprise virtually any conductor—e.g., a monolithic, metallic conductor—that can be joined directly to second electroactive layer 16. The homogeneous ohmic contact may be formed from a single metal or alloy, or it may comprise a base metal with a thin coating of another metal deposited thereon, for example. In contrast to homogeneous ohmic contact 26, heterogeneous ohmic contact 24 may comprise at least two dissimilar conductors, as further described hereinafter.

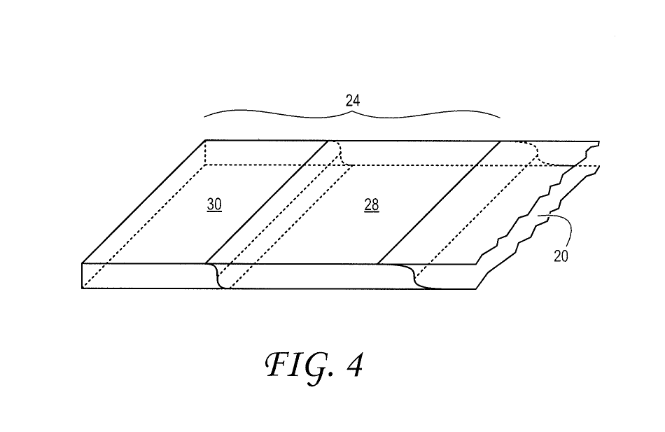

FIG. 4 shows aspects of an example heterogeneous ohmic contact 24 in one embodiment. The illustrated heterogeneous ohmic contact comprises a first conductor 28 and a dissimilar second conductor 30. The first conductor extends from tab portion 20 of first electroactive layer 14 to about half the length of the heterogeneous ohmic contact. In one embodiment, the first conductor may extend 22 mm from the first electroactive layer. The second conductor may extend from this interface another 22 mm, in one example.

First conductor 28 and second conductor 30 may be dissimilar metals. In one embodiment, the first conductor is aluminum, and the second conductor is copper. In a more particular example, copper C102 and aluminum 1100 may be used. In another embodiment, the first conductor is copper, and the second conductor is aluminum. Embodiments involving other dissimilar metals are contemplated as well. The first and second conductors of heterogeneous ohmic contact 24 may be joined in any suitable manner. For example, the conductors may be clad-welded, laser-welded, or ultrasonically welded to each other.

In the embodiments considered herein, homogeneous ohmic contact 26 may be formed from second conductor 30 of heterogeneous ohmic contact 24. In other words, if the second conductor of the heterogeneous ohmic contact is copper, then the homogeneous ohmic contact may be made of copper. If the second conductor of the heterogeneous ohmic contact is aluminum, then the simple conductor may be made of aluminum.

To provide external electrical connection to cell 10, the first conductor of heterogeneous ohmic contact 24 is joined to first electroactive layer 14, and homogeneous ohmic contact 26 is joined to second electroactive layer 16. With reference to the illustrated embodiment, the first conductor of the heterogeneous ohmic contact may be directly joined to a tab portion 20 of the first electroactive layer, and the homogeneous ohmic contact second—via the second conductor—may be joined directly to tab portion 22 of the second electroactive layer. In one embodiment, the first conductor of the heterogeneous ohmic contact may be joined to its corresponding tab portion via an ultrasonically welded joint. Similarly, the second conductor of the homogeneous ohmic contact may be joined to joined to its corresponding tab portion via an ultrasonically welded joint.

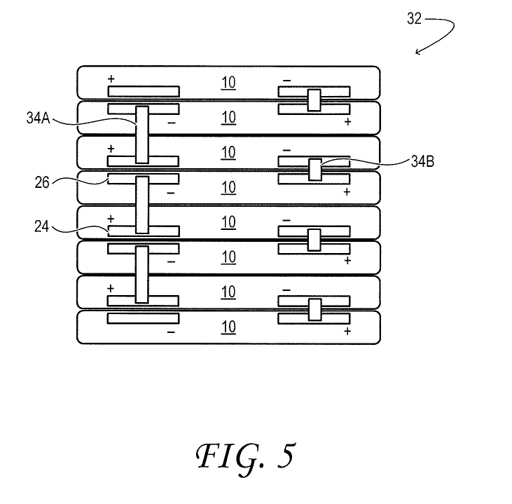

FIG. 5 shows aspects of a storage battery 32 comprising a plurality of substantially equivalent prismatic cells 10, stacked together and connected in series. In this arrangement, the negative terminal of one cell is joined to the positive terminal of an adjacent cell. To connect the cells, heterogeneous ohmic contact 24 of each cell may be joined to homogeneous ohmic contact 26 of a neighboring cell, via the second conductor of the heterogeneous and homogeneous ohmic contacts. In one embodiment, pairs of homogeneous and heterogeneous ohmic contacts may be directly welded together via the second conductor of each. In another embodiment, connectors 34A and 34B may be welded between them. Naturally, the connectors may be made of the second conductor or of a material readily weldable to the second conductor. Accordingly, the cell configurations described hereinabove provide that each weld joint used to construct the storage battery can be homogeneous—i.e., having the same or a compatible material on both sides of the weld. To this end, each electrochemical cell is constructed using a heterogeneous ohmic contact as described above, and, a homogeneous ohmic compound formed from one of the conductors of the heterogeneous ohmic contact.

The configurations described above enable various methods for making a storage battery. Accordingly, some such methods are now described, by way of example, with continued reference to the above configurations. It will be understood, however, that the methods here described, and others fully within the scope of this disclosure, may be enabled by other configurations as well. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

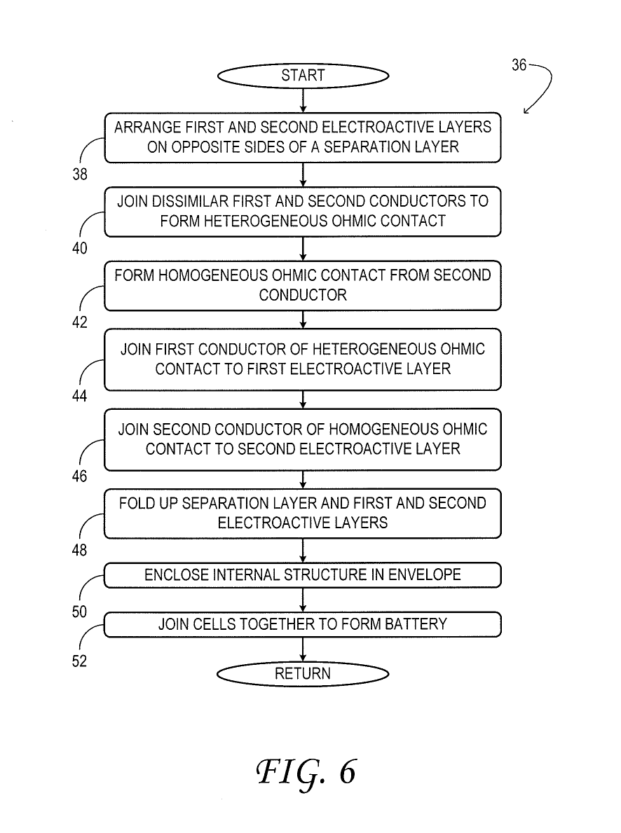

FIG. 6 illustrates an example method 36 for making a storage battery of two or more electrochemical cells. At 38 of method 36, first and second electroactive layers are arranged on opposite sides of a separation layer.

At 40 dissimilar first and second conductors are joined to form a heterogeneous ohmic contact, as described hereinabove. In one embodiment, joining the first and second conductors comprises clad-welding the first and second conductors together. This action may include rolling or pressing the first and second conductors together, and heating to form a joint.

At 42 a homogeneous ohmic contact is formed from the second conductor used to make the heterogeneous ohmic contact.

At 44 the first conductor of the heterogeneous ohmic contact is joined to the first electroactive layer, such that the second conductor is oriented opposite the first electroactive layer. In one embodiment, this action may include ultrasonically welding the first conductor of the heterogeneous ohmic contact to a tab portion of the first electroactive layer, as described hereinabove.

At 46 the second conductor of the homogeneous ohmic contact is joined to the second electroactive layer. This action, likewise, may include ultrasonically welding the second conductor of the homogeneous ohmic contact to a tab portion of the second electroactive layer.

At 48 the separation layer and the first and second electroactive layers are folded up to form a suitable internal cell structure. In one fabrication embodiment, this action may include so-called ‘Z-folding’. In other embodiments, the internal cell structure may be crush-wound or flat-wound. The separation layer and the first and second electroactive layers may be folded such that a plurality of tab portions of the first electroactive layer are arranged in registry with each other, and a plurality of tab portions of the second electroactive layer are arranged in registry with each other. After folding, the plurality of tab portions of the first electroactive layer may be joined together by welding or in any other suitable manner. Similarly, the plurality of tab portions of the second electroactive layer may be joined together.

At 50 the internal structure is enclosed in an envelope. At 52 the enclosed cell and other cells fabricated in the same way are connected together to form a storage battery. The configuration of each individual cell ensures that the terminal ohmic contacts of each cell are made of common conductor, so that the cells can be welded together reliably, both in series and parallel arrangements.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. An electrochemical cell comprising:
first and second electroactive layers;
a heterogeneous ohmic contact comprising dissimilar first and second conductors, the first conductor joined to the first electroactive layer, the second conductor oriented opposite the first electroactive layer; and
a homogeneous ohmic contact comprising the second conductor joined to the second electroactive layer.

2. The cell of claim 1 wherein the first conductor of the heterogeneous ohmic contact is joined to an uncoated area of the first electroactive layer, and wherein the second conductor of the homogeneous ohmic contact is joined to an uncoated area of the second electroactive layer.

3. The cell of claim 1 wherein the first conductor is aluminum, and the second conductor is copper.

4. The cell of claim 1 wherein the first conductor is copper, and the second conductor is aluminum.

5. The cell of claim 1 wherein the cell is one or more of a voltaic cell, a prismatic voltaic cell, and a lithium ion cell, and wherein the first and second electroactive layers are arranged on opposite sides of a separation layer.

6. The cell of claim 5 wherein the first conductor of the heterogeneous ohmic contact is joined to a tab portion of the first electroactive layer protruding beyond the separation layer, and wherein the second conductor of the homogeneous ohmic contact is joined to a tab portion of the second electroactive layer protruding beyond the separation layer.

7. The cell of claim 5 wherein the separation layer and the first and second electroactive layers are folded up and enclosed by an envelope.

8. The cell of claim 7 wherein the tab portions of the first and second electroactive layers are among a plurality of tab portions, and wherein the separation layer and the first and second electroactive layers are folded such that the tab portions of the first electroactive layer are arranged in registry with each other, and the tab portions of the second electroactive layer are arranged in registry with each other.

9. The cell of claim 8 wherein the plurality of tab portions of the first electroactive layer are joined together, and wherein the plurality of tab portions of the second electroactive layer are joined together.

10. The cell of claim 1 wherein the first and second conductors of the heterogeneous ohmic contact are joined via a clad-welded joint.

11. The cell of claim 1 wherein the first conductor of the heterogeneous ohmic contact is joined to the first electroactive layer via an ultrasonically welded joint, and wherein the second conductor of the homogeneous ohmic contact is joined to the second electroactive layer via an ultrasonically welded joint.

12. A method for making a storage battery of one or more electrochemical cells, each cell including first and second electroactive layers, the method comprising:
joining dissimilar first and second conductors to form a heterogeneous ohmic contact;
forming a homogeneous ohmic contact from the second conductor;
joining the first conductor of the heterogeneous ohmic contact to the first electroactive layer, such that the second conductor thereof is oriented opposite the first electroactive layer; and
joining the second conductor of the homogeneous ohmic contact to the second electroactive layer.

13. The method of claim 12 wherein joining the first and second conductors comprises clad-welding the first and second conductors together.

14. The method of claim 13 wherein clad-welding the first and second conductors together comprises rolling or pressing the first and second conductors together, and heating to form a joint.

15. The method of claim 12 wherein joining the first conductor to the first electroactive layer comprises ultrasonically welding the first conductor to the first electroactive layer.

16. The method of claim 12 further comprising arranging the first and second electroactive layers on opposite sides of a separation layer.

17. The method of claim 16 further comprising:
folding up the separation layer and the first and second electroactive layers; and
enclosing the folded separation layer and first and second electroactive layers in an envelope.

18. The method of claim 17 wherein the separation layer and the first and second electroactive layers are folded such that a plurality of tab portions of the first electroactive layer are arranged in registry with each other, and a plurality of tab portions of the second electroactive layer are arranged in registry with each other.

19. The method of claim 18 further comprising joining together the plurality of tab portions of the first electroactive layer; and joining together the plurality of tab portions of the second electroactive layer.

20. A prismatic storage battery comprising:
an electrochemical cell having first and second electroactive layers; a heterogeneous ohmic contact comprising dissimilar first and second conductors, the first conductor joined to the first electroactive layer, the second conductor oriented opposite the first electroactive layer; and a homogeneous ohmic contact comprising the second conductor joined to the second electroactive layer.

21. The battery of claim 20 wherein the cell is one of a plurality of substantially equivalent cells stacked together, with a heterogeneous ohmic contact of a first cell joined to a homogeneous ohmic contact of a second cell via the second conductor of the heterogeneous and homogeneous ohmic contacts.
